(19) United States
(12) Patent Application Publication
(10) Pub. No.: US 2007/0112881 A1
(43) Pub. Date: May 17, 2007

(54) Meeting invitation and group distribution list synchronization

(75) Inventors: Ruthie D. Lyle, Durham, NC (US); Carol S. Zimmet, Boxborough, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/274,575

(22) Filed: Nov. 15, 2005

(51) Int. Cl. G06F 17/30

(52) U.S. Cl. 707/201

(57) ABSTRACT

Under the present invention, a method, system, and program product for synchronizing a group distribution list with a meeting invitation list is provided. The method includes: detecting in the meeting invitation list for any group distribution lists; monitoring the group distribution list(s); detecting any changes in the group distribution list(s); and updating the meeting invitation list with any changes that occurred to the group distribution list(s). The updating may be automatic.

### BACKGROUND OF THE INVENTION

1. Field of the Invention

The present invention relates generally to electronic calendar applications. More specifically, the present invention provides a method, system, and computer program product for synchronizing a group distribution list with a meeting invitation list.

2. Background Art

As the use of computer technology continues to expand, computer users are increasingly communicating with each other via electronic mail (email) and using numerous computer applications to assist in the management of their activities. Electronic calendar applications are commonly used and can be utilized to inter alia create, arrange and manage meeting invitations electronically.

Typically, the person initiating, or tasked with arranging, (i.e., “meeting owner” or “user”) a meeting will, using the electronic calendar application, create a meeting (e.g., select date, time, duration, subject matter, etc.) and extend invitations to the individuals that the meeting owner wishes to attend the meeting and/or select resources (e.g., meeting room, equipment, etc.) that the meeting owner needs for the meeting. Rather than invite all the meeting invitees individually, a Group Distribution List (“GDL”) may be employed. Group Distribution Lists contain a list of individual(s) and/or resource(s) that are linked together with a common focus (e.g., all members are employees in a common department or unit). The GDL may have from one to a near infinite quantity of individuals in it.

Between the time that the meeting owner has extended the invitations and the date of the defacto meeting, the meeting owner will manage the invitation information, meeting invitation list, and meeting status. For example, the meeting owner may monitor who is invited, who has accepted, who has declined, and the like.

The individuals and/or resources on a particular GDL often change. These changes to the GDL may happen at any time. For example, an individual is added to the GDL; a person is removed from the GDL; a resource is removed from the GDL, and the like. Currently, if a GDL is utilized as an invitee to a meeting and a change to the GDL occurs between the time that the invitation is extended and the actual meeting, there is no mechanism to keep the meeting invitees and meeting invitation list in synchronization with any of these ongoing changes to the GDL. There is no automatic feedback function wherein either the meeting invitees are notified and/or the meeting owner is notified of the subsequent change to the GDL that has occurred.

In view of the foregoing, there exists a need for a method, system, and program product for synchronizing Group Distribution Lists with a meeting invitation list.

### SUMMARY OF THE INVENTION

In general, the present invention provides a method, system and program product for synchronizing a Group Distribution List(s) with a meeting invitation list.

A first aspect of the present invention provides a method of synchronizing a group distribution list with a meeting invitation list in an electronic calendar application environment wherein a calendar event including a meeting invitation list is created, comprising the steps of: detecting a group distribution list in the meeting invitation list; monitoring the group distribution list; detecting a change in the group distribution list; and updating the meeting invitation list with the change.

A second aspect of the present invention provides a system for synchronizing a group distribution list with a meeting invitation list comprising: a system for detecting a group distribution list in the meeting invitation list; a system for monitoring the group distribution list; a system for detecting a change in the group distribution list; and a system for updating the meeting invitation list with the change.

A third aspect of the present invention provides program product stored on a recordable medium for program product stored on a computer readable medium for synchronizing a group distribution list with a meeting invitation list, the computer readable medium comprising program code for performing the steps of: detecting a group distribution list in the meeting invitation list; monitoring the group distribution list; detecting a change in the group distribution list; and updating the meeting invitation list with the change.

A fourth aspect of the present invention provides a method of synchronizing a group distribution list with a meeting invitation list, comprising the steps of: detecting a change in a group distribution list; and automatically updating the meeting invitation list pursuant to the change in the group distribution list.

A fifth aspect of the present invention provides deploying an application for synchronizing a group distribution list with a meeting invitation list, comprising: providing a computer infrastructure being operable to: detect a group distribution list in the meeting invitation list; monitor the group distribution list; detect a change in the group distribution list; and update the meeting invitation list with the change.

A sixth aspect of the present invention provides computer software embodied in a propagated signal for synchronizing a group distribution list with a meeting invitation list, the computer software comprising instructions to cause a computer system to perform the following functions: detecting a group distribution list in the meeting invitation list; monitoring the group distribution list; detecting a change in the group distribution list; and updating the meeting invitation list with the change.

Therefore, the present invention provides a method, system, and program product for synchronizing a group distribution list(s) with a meeting invitation list.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an exemplary calendar application interface.

FIG. 2 depicts an exemplary invitee interface.

FIG. 3 depicts an exemplary Group Distribution List (GDL) interface.

FIG. 4 depicts a flow diagram for a portion of a method for synchronizing a GDL with a meeting invitation list in accordance with the present invention.

FIG. 5 depicts a flow diagram for a portion of the method for synchronizing a GDL with a meeting invitation list in accordance with the present invention.

FIG. 6 depicts a flow diagram for a portion of the method for synchronizing a GDL with a meeting invitation list in accordance with the present invention.

FIG. 7 depicts a flow diagram for a portion of the method for synchronizing a GDL with a meeting invitation list in accordance with the present invention.

FIG. 8 depicts a computerized system for synchronizing a GDL with a meeting invitation list in accordance with the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system and program product for synchronizing a Group Distribution List (GDL) with a meeting invitation list, as is typically found in electronic calendar applications. In accordance with the present invention, if a user of calendar software decides to arrange a meeting and extend invitations to invitees, wherein at least one invitee is a GDL, any changes over time to the GDL will automatically be reflected in the meeting invitees.

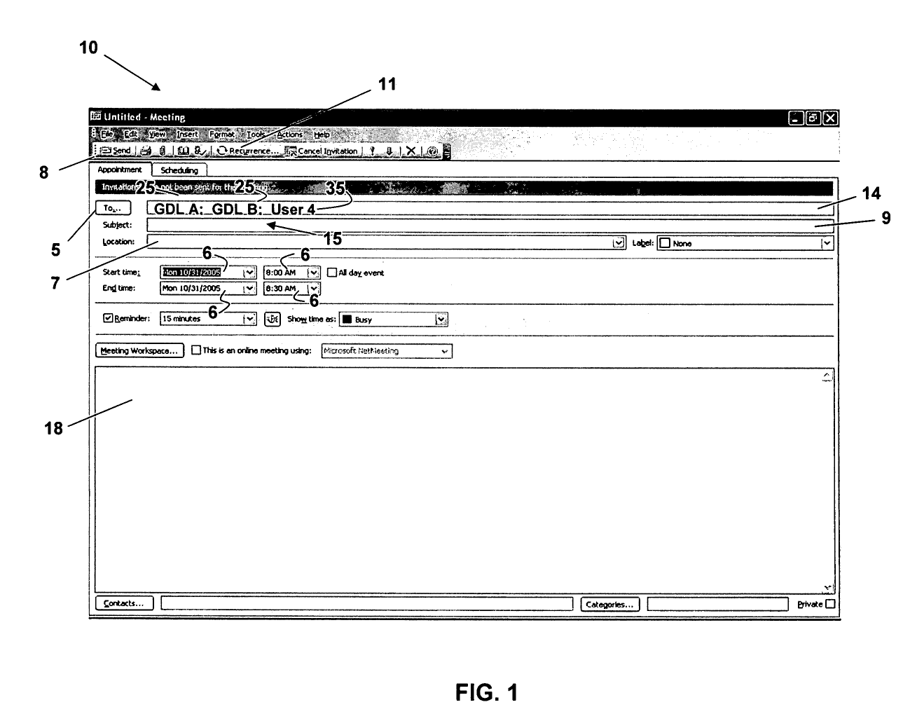

FIG. 1 shows an exemplary calendar application interface, depicted as 10. The interface 10 may include various ancillary fields such as subject line 9, location 7, note area 18, meeting invitee 14, and the like. In general, the calendar application interface 10 allows inter alia a user (e.g., “meeting owner”) to schedule a meeting, extend invitations to invitees, receive acceptances from invitees, and the like. The date and time of the meeting are specified in the various fields denoted by 6. By selected a recurring option 11, the meeting owner can even create a meeting invitation for a periodically occurring (i.e., recurring) meeting (e.g., Friday meetings, etc.).

The user may enter into the invitee field 14 one, or more, invitees to the scheduled meeting thereby effectively creating an invitation list 15. Satisfactory filling out of entries in the invitee field 14, the user then may send this invitation, or notice, of the meeting to the various invitees on the invitation list 15 by clicking on the “Send” button 8. The invitations are sent out to the invitees on the invitation list 15 for their acceptance, denial, or other response to the invitation. For example, in FIG. 1, the invitation list 15 includes two GDL's 25 (i.e., “GDL A” and “GDL B”) and one individual 35 (i.e., “User4”).

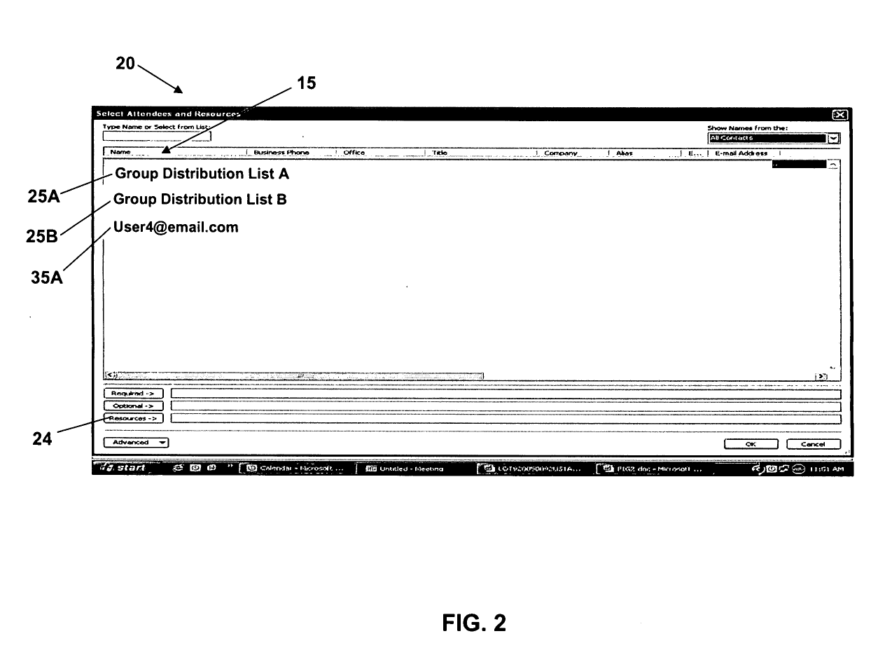

As shown in FIG. 2, the various invitees on the invitation list 15 specified in the invitee field 14 (FIG. 1) may be an individual 35, a resource 24, a GDL 25, or a plurality of any of the aforementioned. By selecting the “To” button 5 (FIG. 1), a screen offering various invitee choices for the invitation list 15 may drop down to the meeting owner.

The screen allowing for selecting the various meeting invitees on the meeting invitation list 15, depicted as 20, allows the meeting owner to make one, or more selections as to who should be extended an invitation to the meeting. As shown, a plurality of invitees on the invitation list 15 may be specified. For example, a first GDL 25A (e.g., “Group Distribution List A”), a second GDL 25B (e.g., “Group Distribution List B”), and an individual 35A (e.g., User4@email.com) are specified as the invitees 15 for the exemplary meeting invitation being created in FIGS. 2 and 1. Additionally, resources 24 may be selected for the meeting. Upon acceptance of the selections made on the invitee screen 20, and selection of “send” finction 8 on the create meeting screen 10 (FIG. 1), invitations to the various invitees on the meeting invitation list 15 are sent.

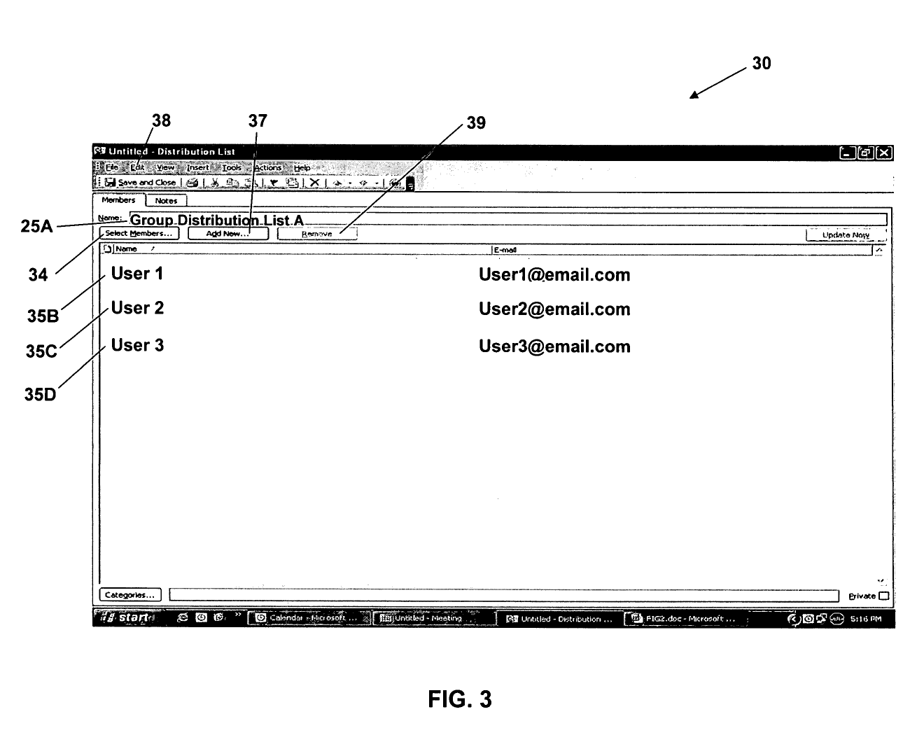

FIG. 3 depicts a GDL screen interface 30 for a particular GDL 25A (i.e., Group Distribution List A). As shown, GDL 25A includes three individuals 35 (e.g., User1 35B, User2 35C, and User3 35D) with their respective email addresses (i.e., User1@email.com; User2@email.com; and, User3@email.com). At any point in time, a meeting owner (or other) with suitable access to the screen 30 may select an individual (via 34) and then delete (via 39), or edit (via 38) information regarding the individuals 35 on the GDL 25A. Similarly, a new individual 35 may be added to the GDL 25A via the “add” selection 37.

Similarly, a meeting owner (or other) with suitable access may also change an available resource 24 (FIG. 2). For example, a resource 24 may too be deleted (e.g., conference room is no longer available), added (e.g., new equipment is purchased and available), and changed (e.g., resource has changed in type or description).

By synchronizing a GDL 25 to the invitation list 15, the present invention provides for an automatic updating of the invitees on the meeting invitation list 15 of any changes that are made to the GDL 25. In one embodiment of the present invention, when the meeting invitation list 15 is created for a particular meeting, and a particular GDL 25 is referenced and validated, a dynamic list entry is created which tracks the GDL 25 to the associated meeting invitation.

The invention will detect any changes to the GDL 25 by noting the distribution list update field that reflects the change(s) and resave of the GDL 25. The process that scans the distribution list update field may be run on a daily basis (e.g., during “off hours”). Whenever a match is found for the current day, an analysis is performed to detect if there were any additions and/or deletions of names in the GDL 25. If the appropriate change type did occur upon the detection, a result list may be formed.

Updates are needed to the dynamic list associated with the distribution list, over time. For example, if the meeting has already occurred the dynamic list needs to be updated. Similarly, if the meeting is cancelled, a similar update needs to occur. The analysis and updating can happen via a separate task, by running off hours. For example, this activity may be done on a weekly basis during an “off hour” time (e.g., weekends, holidays, evenings, etc.).

In the case of adding a person to the GDL 25 after the meeting invitation is created, a meeting invitation is generated and automatically sent to the new person on the GDL 25.

Other aspects of the invention include various notification system aspects. For example, upon the detection and/or meeting update processing (e.g., generate invite, removing name from distribution list 25), a summary document may be sent to the meeting owner. Also, a trace, or logging, function is available, wherein a historical record of the changes and updates is kept. The historical record may include what changes are detected, what changes are updated, when changes are updated, and the like. For example, if an individual is removed from a repeating meeting, a record of when the particular person is removed is made. A reason for the removal is also identified. Thus summary information may be made available to the calendar owner via calendar GUI.

Other functionalities are available for special situations in the calendar application. For repeating appointments (e.g. activated by “recurrence” selection 22 at FIG. 1), wherein one entry is made and requested to repeat based against a known timeline, the present method is available to be able to detect and respond to changes in a GDL 25 employed in a meeting invite.

Another function may be to allow for various administrative overrides offered to a user or administrator. For example, the feature of updating (i.e., synchronizing) may have an option wherein it may be disabled entirely (i.e., turned “off”), it may be set for automatic updating, or it may be set for selective updating by a user (e.g., the user is prompted for updating for each detected change, the user is prompted for updating for a certain type of detected change, and the like). The override may include prompts to the meeting owner, first, asking if the change should be implemented, thereby allowing the meeting owner to selectively select what changes should be implemented on a case-by-case basis. With any override function, it may also be enabled on a site-specific basis.

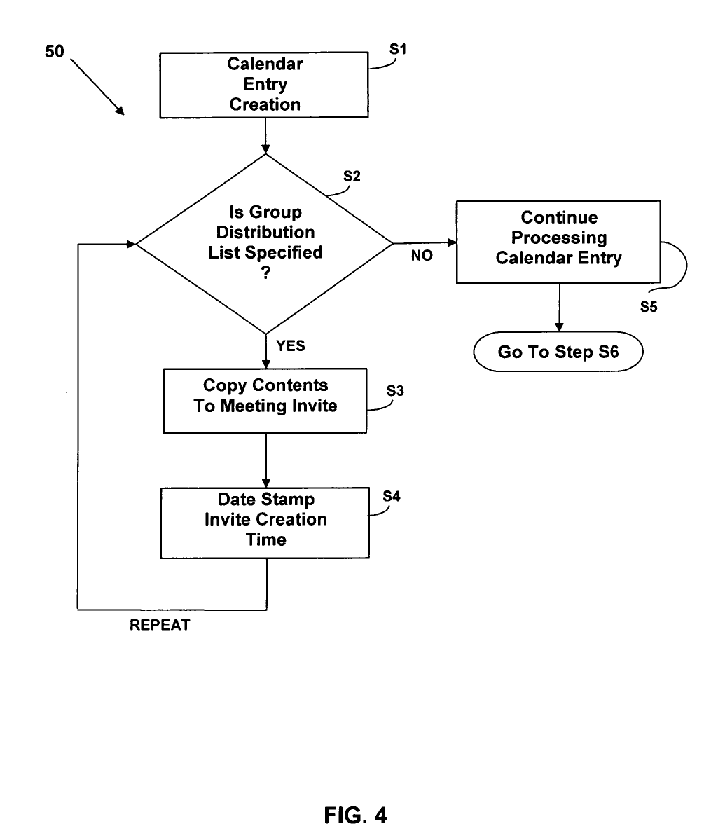

The various steps of a method 50, in accordance with the invention, are depicted in order in FIGS. 4 through 7, wherein a calendar entry is created at step S1. Upon the creation of the calendar entry, step S2 checks to see if a GDL was specified. If no GDL was specified in the calendar entry creation, then the method 50 processes the calendar entry at step S5 in typical fashion.

If at step S2 is affirmative, then step S3 occurs, wherein the contents of the GDL are copied into the meeting invite. Step S4, that follows, includes the step of creating a date stamp of the date and/or time of the invite creation. Steps S2, S3, and S4 are thereby continued, as required, until no more GDL's remain, at which the method 50 proceeds to step S5.

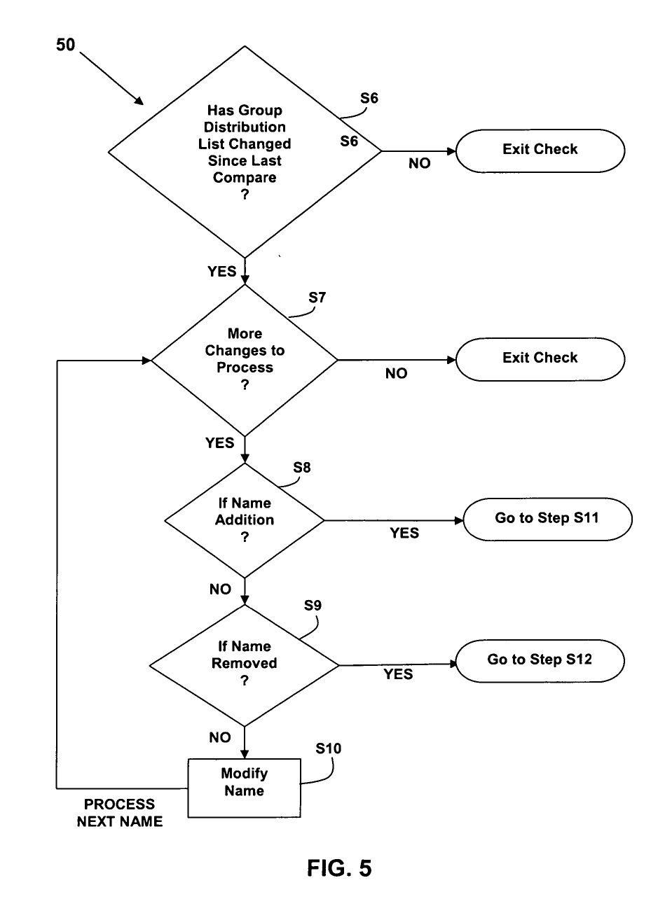

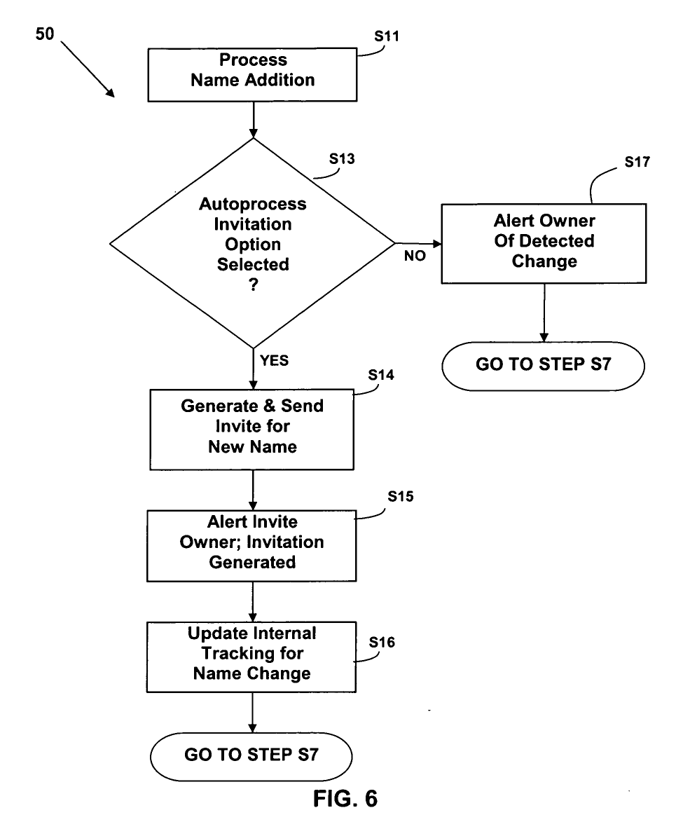

Turning to the portion of the method 50 depicted in FIG. 5, step S6 checks whether a change has occurred since the last comparison of the GDL. If step S6 results in a negative, the method proceeds to exiting the check. Upon an affirmative to step S6, the method proceeds to step S7 which is merely a verification if there are more changes to process, or update. There are essentially three types of possible changes to process, namely a name has been added (i.e., “name addition”); a name has been removed; or, a modification of name (or information) to an existing invitee. If step S7 is negative, there are no more changes to process, and thus the method exits the checking. Conversely, if step S7 is positive, the method proceeds to checking in step S8 if the change detected in the comparison (step S6) is a name addition to the GDL. If step S8 is affirmative, the method 50 proceeds to processing a name addition, step S11 (see FIG. 6).

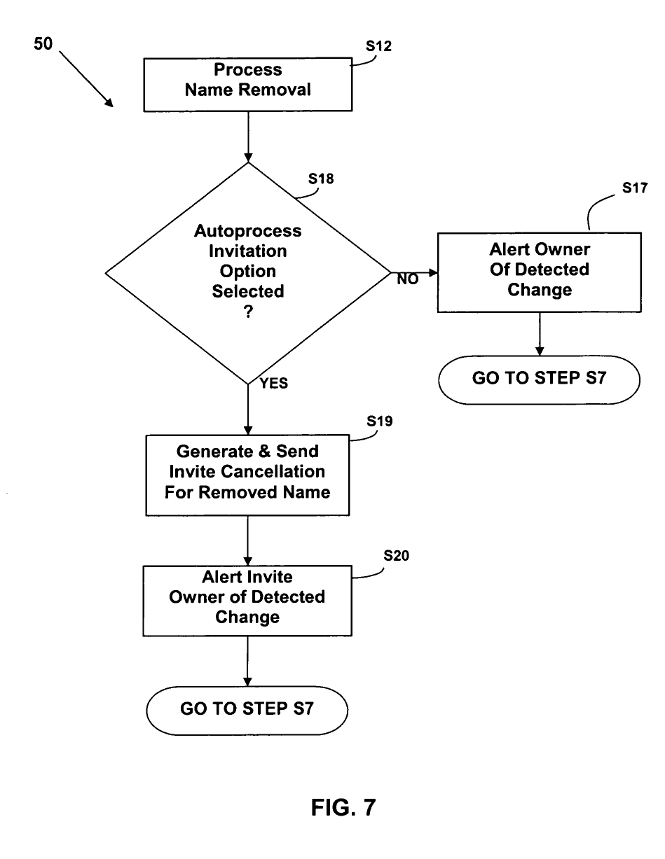

If there is no name addition (i.e., step S8 is negative), step S9 checks if there was a name removed from the GDL. Similarly, if the result of step S9 is affirmative, the method 50 proceeds to the processing of a name removal at step S12 (see FIG. 7).

If step S9 is negative, then step S10 logically follows wherein the detected change must be a modification to a name. Thus, step S10 is updating, or processing, of the name modification. When the name is modified in step S10, then the method 50 proceeds back to step S7 to verify if there are more changes to be processed.

This series of steps depicted in FIG. 5 is repeated for each name on the GDL until the names on the list have all been reviewed for changes.

This entire series of steps in FIG. 5 may be conducted on a daily basis (e.g., during off-hours) so that any change in a GDL may be detected readily and then concomitantly updated per the steps outlined in FIGS. 5, 6 and 7.

Step S11 (FIG. 6) commences the processing of the detected name addition. If an autoprocess invitation option is not selected, at step S13, then step S17 alerts the meeting owner of the detected change (i.e., name addition). Conversely, if at step S13, the autoprocess invitation option is selected, the method 50 proceeds to process the name addition automatically via steps S14, S15, and S16.

Step S14 generates and sends a meeting invitation to the new name. Step S15 follows wherein the meeting owner is alerted and an invitation is generated. Finally, Step S16 updates the internal tracking for the name change. Upon the completion of either step S16 or step S17, the method 50 proceeds back to step S7 (FIG. 5) to verify if there are more changes to be processed.

Upon a detection of a name removal, method 50 proceeds to step S12 (FIG. 7) and the concomitant steps for processing the removal of the name. Similarly, if an autoprocess invitation option is not selected, at step S18, then step S17 alerts the meeting owner of the detected change (i.e., name removal). Conversely, if at step S18, the autoprocess invitation option is selected, the method 50 proceeds to process the name removal automatically via steps S19 and S20. Similarly, Step S19 generates and sends an invitation cancellation to the removed name. Step S20 follows wherein the meeting owner is alerted of the detected change (i.e., name removal). Upon the completion of either step S17 or step S20, the method 50 proceeds back to step S7 (FIG. 5) to verify if there are more changes to be processed.

The present invention ultimately provides the advantage of synchronizing a GDL with a meeting invitation list

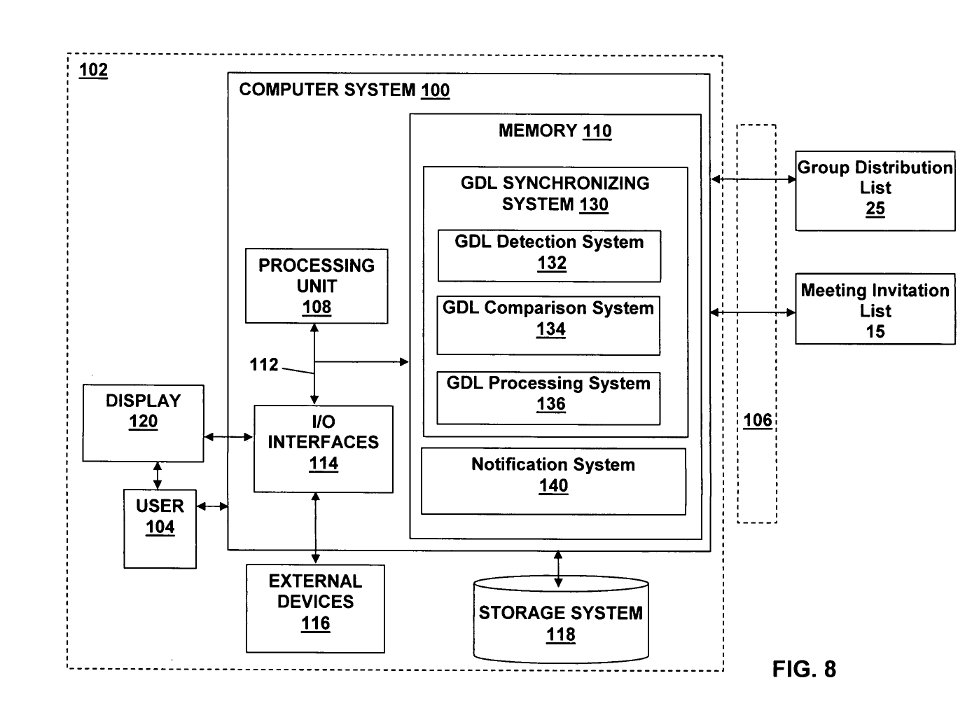

A computer system 100 for synchronizing a Group Distribution List with a meeting invitation list in accordance with an embodiment of the present invention is depicted in FIG. 8. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for synchronizing a group distribution list with a meeting invitation list, in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as Group Distribution List (GDL) synchronizing system 130, and notification system 140, that are stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 8 can be included in computer system 100. However, if computer system 100 comprises a handheld device or the like, it is understood that one or more external devices/resources 116 (e.g., display 120) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is a GDL synchronizing system 130 for synchronizing a Group Distribution List 25 with a meeting invitation list 15 in accordance with embodiment(s) of the present invention. The GDL synchronizing system 130 generally includes a GDL detection system 132 for detecting the use of any GDL(s) 25 in the creation of a meeting, as described above. The GDL comparison system 134 includes a comparing, or checking, function so as to continually, or periodically, compare the detected and employed GDL(s) 25 for any changes, as described above. The GDL synchronizing system 130 generally includes a GDL processing system 136 for processing all found changes to the GDL 25 and for processing the changes back in the meeting invitation list 15.

Further in memory 110 may be a notification system 140 that includes notifying the user 104 of any changes detected via the GDL comparison system 134 and of any updates conducted by the GDL processing system 136.

The present invention can be offered as a business method on a subscription or fee basis. For example, one or more components of the present invention can be created, maintained, supported, and/or deployed by a service provider that offers the functions described herein for customers. That is, a service provider can be used to provide a service for synchronizing a Group Distribution List with a meeting invitation list, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method of synchronizing a group distribution list with a meeting invitation list in an electronic calendar application environment wherein a calendar event including a meeting invitation list is created, comprising the steps of:
detecting a group distribution list in the meeting invitation list;
monitoring the group distribution list;
detecting a change in the group distribution list; and
updating the meeting invitation list with the change.

2. The method of claim 1, wherein the change is selected from a group consisting of: name addition, name deletion, information change, and combinations thereof.

3. The method of claim 1, wherein the updating step is automatic.

4. The method of claim 1, further comprising:
monitoring when the group distribution list was last changed.

5. The method of claim 1, wherein the group distribution list comprises a plurality of group distribution lists.

6. The method of claim 1, wherein the calendar event comprises a recurring event.

7. The method of claim 1, further comprising the step:
notifying a user of the group distribution list of the change in the group distribution list and the update in the meeting invitation list.

8. The method of claim 1, wherein updating further comprises a user selectively updating the meeting invitation list with the change.

9. The method of claim 1, further comprising:
creating a record of the change, wherein the record includes one selected from the group consisting of: a time of change, a type of change, a detail of change, and combinations thereof.

10. A system for synchronizing a group distribution list with a meeting invitation list comprising:
a system for detecting a group distribution list in the meeting invitation list;
a system for monitoring the group distribution list;
a system for detecting a change in the group distribution list; and
a system for updating the meeting invitation list with the change.

11. The system of claim 10, wherein the change is selected from a group consisting of: name addition, name deletion, information change, and combinations thereof.

12. The system of claim 10, wherein the updating system acts automatically.

13. The system of claim 10, further comprising:
a system for monitoring when the group distribution list was last changed.

14. The system of claim 10, wherein the meeting invitation list pertains to a recurring event.

15. The system of claim 8, further comprising:
a system for notifying a user of the group distribution list of the change in the group distribution list and the update in the meeting invitation list.

16. The system of claim 8, wherein the updating system further comprises system for selectively updating the meeting invitation list with the change.

17. The system of claim 8, further comprising:
a system for creating a record of the change, wherein the record includes one selected from the group consisting of: a time of change, a type of change, a detail of change, and combinations thereof.

18. A program product stored on a computer readable medium for synchronizing a group distribution list with a meeting invitation list, the computer readable medium comprising program code for performing the steps of:
detecting a group distribution list in the meeting invitation list;
monitoring the group distribution list;
detecting a change in the group distribution list; and
updating the meeting invitation list with the change.

19. A method of synchronizing a group distribution list with a meeting invitation list, comprising the steps of:
detecting a change in a group distribution list; and
automatically updating the meeting invitation list pursuant to the change in the group distribution list.
